(19) United States
(12) Patent Application Publication
(10) Pub. No.: US 2013/0294057 A1
(43) Pub. Date: Nov. 7, 2013

(54) Awareness Ribbon Novelty Lamp Assembly

(71) Applicant: Richard J. Schwartz, South Elgin, IL (US)

(72) Inventor: Richard J. Schwartz, South Elgin, IL (US)

(21) Appl. No.: 13/886,408

(22) Filed: May 3, 2013

Related U.S. Application Data
(60) Provisional application No. 61/687,974, filed on May 4, 2012.

(51) Int. Cl. F21V 33/00; F21V 3/00; F21L 4/08

(52) U.S. Cl. CPC F21V 33/00; F21L 4/08; F21V 3/00
USPC 362/186; 362/362; 362/190; 362/311.06; 362/293; 362/382

(57) ABSTRACT

An awareness ribbon novelty lamp assembly provides an illuminated awareness novelty in low light conditions. The lamp assembly includes a three-dimensional, awareness ribbon construction and a cap assembly. The awareness ribbon construction is constructed from a light-penetrative material and defines an awareness ribbon shape. The upper end of the ribbon construction includes an assembly-receiving aperture intermediate anterior and posterior ribbon portions. The cap assembly includes an aperture-closing construction and a light assembly. The light assembly is receivable in the assembly-receiving aperture, and the closing construction caps the assembly-receiving aperture. The light assembly provides illumination internally to the awareness ribbon construction for enabling onlookers to readily visualize the ribbon construction.

### BACKGROUND OF THE INVENTION

1. Field of the Invention

The present invention generally relates to a lamp assembly. More particularly, the present invention relates to a lamp assembly formed so as to resemble an awareness ribbon for illuminating the ribbon form in low light conditions for enhancing awareness of a given concern.

2. Discussion of the Prior Art

U.S. Pat. No. 4,702,140 ('140 patent), which issued to Goldfarb, discloses Solar-Powered Musical Ornaments and Novelties. The '140 patent describes small, inexpensive ornaments and novelties which emit music and other sounds (such as simulated voice) when exposed to light, and can be placed out-of-doors in a garden. Being light-powered, they can operate for an essentially indefinite time, even though unattended. Each such ornament or novelty consists of a thematically configured body and a three-element working module sealed in a watertight can. It has no input keyboard or other terminal, and no display panel or other electronic or visual data output, except the audio output.

Elements are a circuit, preprogrammed to produce electronic oscillations corresponding to a tune or other sounds pre-established at manufacture, a speaker receiving the oscillations and emitting the sounds, and a solar panel powering the circuit. The speaker shuts off if light is inadequate for completely correct operation, and otherwise is amplitude modulated by the light level. The decorative body, the detailed programming of the circuit, and the particular tune or other sounds are coordinated in theme.

U.S. Pat. No. 5,410,458 ('458 patent), which issued to Bell, discloses Illuminated Landscape Edging. The '458 patent describes illuminated landscape edging comprising a planar member which is structured to be implanted into the ground and by a tubular member which is structured to be located above ground. In the preferred form of the invention, the tubular member is light passable and is provided with a slit running its length. Both the planar and tubular members are integrally constructed of plastic. The illuminated landscape edging is elongated and is provided in long rolls which may be cut into sections to suit the length needs of a particular landscaping job. Sections of the illuminated landscape edging are joined by a slotted tubular connector inserting into open ends of adjoining tubular members.

A lighting string, such as miniature Christmas lights, is inserted into the tubular member via passage through the slit in the tubular member progressively therealong. A slot in the slotted tubular connector enables the lighting string to be passed therethrough, as well. At a selected location along the slit in the tubular member, the wiring of the lighting string exits the tubular member to be connected externally to a power source of electricity, which may be the home utility service or a solar energy storage power system. In the nighttime hours, the lighting string is illuminated, thereby providing a pleasant line of light which follows the predetermined demarcation pattern of the illuminated landscape edging.

U.S. Pat. No. 6,406,163 ('163 patent), issued to Yang, discloses a Solar Cell Lighting Fixture Integrated with Heat Sink. The '163 patent describes a solar cell lighting fixture adapted to a lantern, a garden light, a wall fitting, a portable lighting fixture or other lighting fixtures, or on a mobile vehicle including an automobile, a sea vessel, an aircraft, a bicycle, or a motorcycle. A support structure with a predetermined configuration is provided between an upper lid with a solar cell panel, and a bulb is provided below the upper lid. A bulb housing contains battery components, such as a secondary cell or a battery capacitor, a charging circuit or a component to convert electrical energy into optical energy, and operation and control circuits.

U.S. Pat. No. 6,729,742 ('742 patent), which issued to Wismeth et al, discloses a Solar Lamp for Outdoor Use. The '742 patent describes a garden lamp, road or street lamp or such, comprising one or more solar module, and a housing with a storage means for electric energy (battery), which is electrically connected to the solar module, and one or more luminous body, whereby between the battery and the luminous body a circuit is provided, which reacts to signals from a light sensor attached to the solar lamp, and which enables or disables the electrical connection between the battery and the luminous body depending on the degree of brightness/darkness, whereby the housing is provided with two or more walls of different orientation which do not converge parallel to each other, and whereby one or more solar modules are arranged on each wall, or that the walls are formed by solar modules.

U.S. Pat. No. 7,172,307 ('307 patent), which issued to Izardel, discloses a Solar Powered Garden Light. The '307 patent describes a garden light assembly comprising a solar cell assembly adapted for supplying electric current, at least one light mounted on a mounting plate and in electrical communication with the solar cell assembly, and a refractor/reflector positioned to reflect outwards light rays emanating from the at least one light, the refractor/reflector including a curved surface concavely curved with respect to the at least one light.

U.S. Pat. No. 7,740,177 ('177 patent), which issued to Weiser, discloses a Solar Light Stick. The '177 patent describes a solar light stick for use as a lawn or garden novelty. The solar light stick has a support member, a solar panel, a rechargeable battery, an LED, and a wand. The wand contains a light transmissive material that may be transparent or translucent. The solar panel charges the rechargeable battery which, in turn, provides power to the LED. The LED is positioned to provide light to the interior of the wand. As such, the LED may be located within a recess in the wand. Voids, such as interior bubbles, suspended objects, or surface irregularities may help to disperse light from the LED in a direction external to the wand.

U.S. Pat. No. 7,888,584 ('584 patent), which issued to Lyden, discloses a Solar Cell, Module, Array, Network, and Power Grid. The '584 patent describes said items suitable for providing power for industrial, residential and transportation use. A solar cell or solar module including a plurality of solar cells can be made in a structure configured to have the appearance of natural foliage. Accordingly, a solar array including a plurality of solar modules each including at least one solar cell can be made to resemble a palm tree, a deciduous tree, an evergreen tree, or other type of natural foliage.

A network of solar arrays can be made to resemble a row or grove of palm trees, and thus meet the functional and aesthetic demands of landscape architecture. The network of solar arrays can extend for many miles alongside roads, highways, railways, pipelines, or canals, and can further include means for storing and transmitting electric power. In particular, a network of solar arrays can be in communication with recharging stations for use by electric and hybrid transportation vehicles. Accordingly, a network of solar arrays can form at least a portion of a solar power grid.

United States Patent Application Publication No. US 2008/0185988 which was authored by Fan, describes a solar garden light device which has at least one lamp, a rechargeable device and a solar array. Each one of the at least one lamp has a casing, a through hole and a light assembly. The casing has a top end. The through hole is defined in the casing adjacent to the top end. The light assembly is mounted in the casing and lights. The rechargeable device has a control circuit and a rechargeable battery. The rechargeable battery is connected electrically to the control circuit and the light assembly. The solar array is connected electrically to the control circuit, converts sunlight to direct current (DC) electricity and recharges the rechargeable battery. Therefore, the solar array can absorb solar energy and transfer solar energy to electric energy to store electricity in the rechargeable battery. Then the rechargeable battery supplies power to the light.

United States Patent Application Publication No. US 2010/0085742, which was authored by Ip, describes a solar powered garden light that can be used to indicate a direction. LEDs are situated in a pattern, such as an arrow, on a platform which can be rotated. A user can adjust the direction that the solar powered garden light indicates by rotating the platform. The platform can be rotated by turning a knob. A solar cell is used to charge batteries, where these batteries are used to power the LEDs. The same solar cell can also act as a switch that turns the lights on and off.

### SUMMARY OF THE INVENTION

Awareness ribbons have come to symbolize various concerns depending on the colors or the patterns used. For example, black ribbons may be used for mourning; yellow ribbons may be utilized to demonstrate that a close family member is abroad in military service. Of the uses of ribbons to draw awareness to health issues, perhaps the best-known is the red ribbon for support of those with acquired immunodeficiency syndrome (AIDS). Other health and social concerns which have adopted coloored ribbons include Alzheimer's disease (purple), Breast Cancer (pink), bipolar disorder (green), and brain disorder or disability (silver).

Building on the development of the awareness ribbon, the present invention contemplates an awareness ribbon novelty lamp assembly. The lamp assembly comprises a molded form being molded from a semi-translucent material, and a lamp-based assembly with standard circuitry to power and illuminate an illumination source. The form may well comprise a front section and a back section. A lamp assembly may include a solar cell or array of solar cells (or a battery) for powering the circuit, a light-emitting diode (LED) or similar other light source for illuminating the molded form, and circuitry for directing power to the light source. The illuminated ribbon form when illuminated, enhances awareness of the color-coded concern affiliated therewith by way of the color and illumination of the ribbon form.

### BRIEF DESCRIPTION OF THE DRAWINGS

Other features of my invention will become more evident from a consideration of the following brief descriptions of drawings:

FIG. 1 is a top anterior perspective view of a preferred awareness ribbon lamp assembly according to the present invention.

FIG. 2 is a top posterior perspective view of the preferred awareness ribbon lamp assembly according to the present invention.

FIG. 3 is a front or anterior elevational view of the preferred awareness ribbon lamp assembly according to the present invention.

FIG. 3(a) is a top or superior plan type view of the preferred awareness ribbon lamp assembly according to the present invention.

FIG. 3(b) is a longitudinal cross-sectional view of the preferred awareness ribbon lamp assembly according to the present invention.

FIG. 3(c) is a bottom or inferior plan type view of the preferred awareness ribbon lamp assembly according to the present invention.

FIG. 3(d) is a right lateral elevational view of the preferred awareness ribbon lamp assembly according to the present invention.

FIG. 4 is a rear or posterior elevational view of the preferred awareness ribbon lamp assembly according to the present invention.

FIG. 5 is an enlarged front or anterior elevational view of the preferred awareness ribbon lamp assembly according to the present invention.

FIG. 6 is an enlarged longitudinal cross-sectional view of the preferred awareness ribbon lamp assembly according to the present invention.

FIG. 7 is a top or superior plan view of the cap assembly of the preferred awareness ribbon lamp assembly according to the present invention.

FIG. 8 is a bottom or inferior plan view of the cap assembly of the preferred awareness ribbon lamp assembly according to the present invention.

FIG. 9 is a top or superior perspective view of the cap assembly of the preferred awareness ribbon lamp assembly according to the present invention.

FIG. 10 is a bottom or inferior perspective view of the cap assembly of the preferred awareness ribbon lamp assembly according to the present invention.

FIG. 11 is a side elevational view in a first dimension of the cap assembly of the preferred awareness ribbon lamp assembly according to the present invention.

FIG. 12 is a side elevational view in a second dimension of the cap assembly of the preferred awareness ribbon lamp assembly according to the present invention.

FIG. 13 is a cross-sectional view in the second dimension of the cap assembly of the preferred awareness ribbon lamp assembly according to the present invention.

FIG. 14 is an enlarged right lateral elevational view of the awareness ribbon construction or form according to the present invention.

FIG. 15 is an enlarged left lateral elevational view of the awareness ribbon construction or form according to the present invention.

FIG. 16 is an enlarged top or superior plan view of the awareness ribbon construction or form according to the present invention.

FIG. 17 is an enlarged bottom or inferior plan view of the awareness ribbon construction or form according to the present invention.

FIG. 18 is a diagrammatic depiction of three awareness ribbon novelty lamps places side by side from left to right showing (1) an illuminated anterior view of a first pink-colored lamp assembly, (2) a right lateral view of the second white lamp assembly, and (3) a posterior view of a third white lamp assembly, all shown anchored to the earth via a stake assembly.

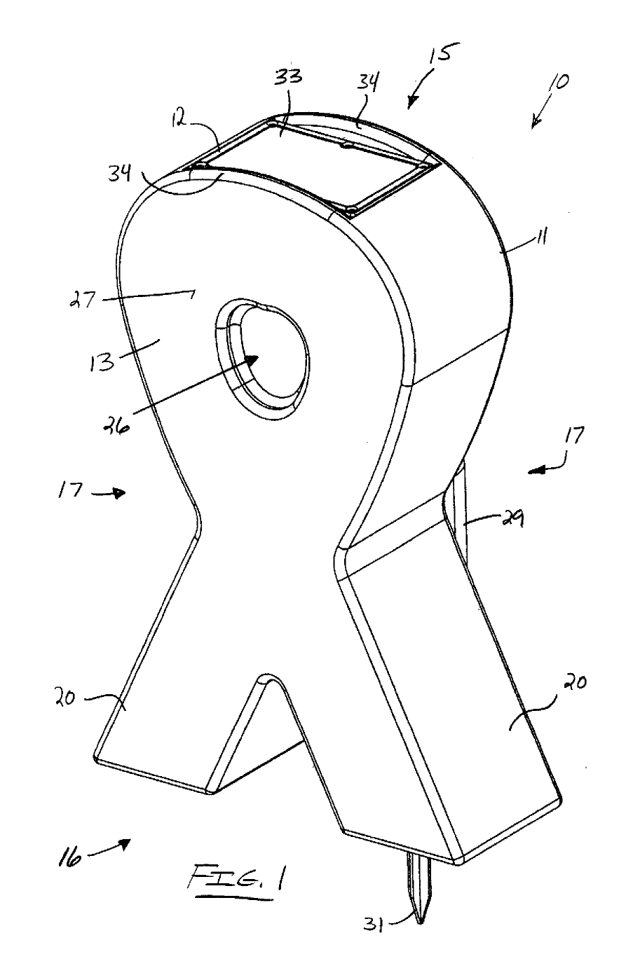

### DETAILED DESCRIPTION OF THE PREFERRED EMBODIMENT

Referring now the drawings with more specificity, the present invention essentially provides an awareness ribbon novelty lamp assembly or novelty lamp assembly as at 10 in the form of an awareness ribbon for providing an illuminated awareness novelty generally in low light conditions. The novelty lamp assembly 10 according to the present invention preferably comprises a three-dimensional, awareness ribbon construction or form as at 11; a cap assembly as at 12; and certain anchoring means.

The awareness ribbon construction or form 11 is preferably constructed from a semi-light transparent material as may be supplied by any number of moldable polymeric materials, which moldable materials may be provided with select coloration for conveying awareness ribbon meaning to passersby or onlookers. Alternatively, it is contemplated that the material may be made translucent or clear and the light conveyed from the light assembly may be of a select coloration.

Alternatively, it is further contemplated that the translucent form may be outfitted (i.e. colored materials or media may be added to surfacing of the form 11) with select coloration to effect the desired coloration. Preferably, however, the form 11 is provided with the select coloration in the molded material which provides for a more robust coloration in low light conditions. Excellent results have been obtained utilizing a selectively colored (e.g. pink as depicted with hatch markings 103 in FIG. 18) polymeric material in the molded form 11.

The three-dimensional awareness ribbon form 11 preferably comprises an anterior ribbon or form portion as at 13; a posterior ribbon or form portion as at 14; a superior ribbon or form end as at 15; an inferior ribbon or form end as at 16; laterally opposed ribbon or form portions as at 17; and a transverse ribbon plane as at 100 intermediate the superior and inferior ribbon or form ends 15 and 16 defining an upper ribbon or form portion as at 18, and a lower ribbon or form portion as at 19.

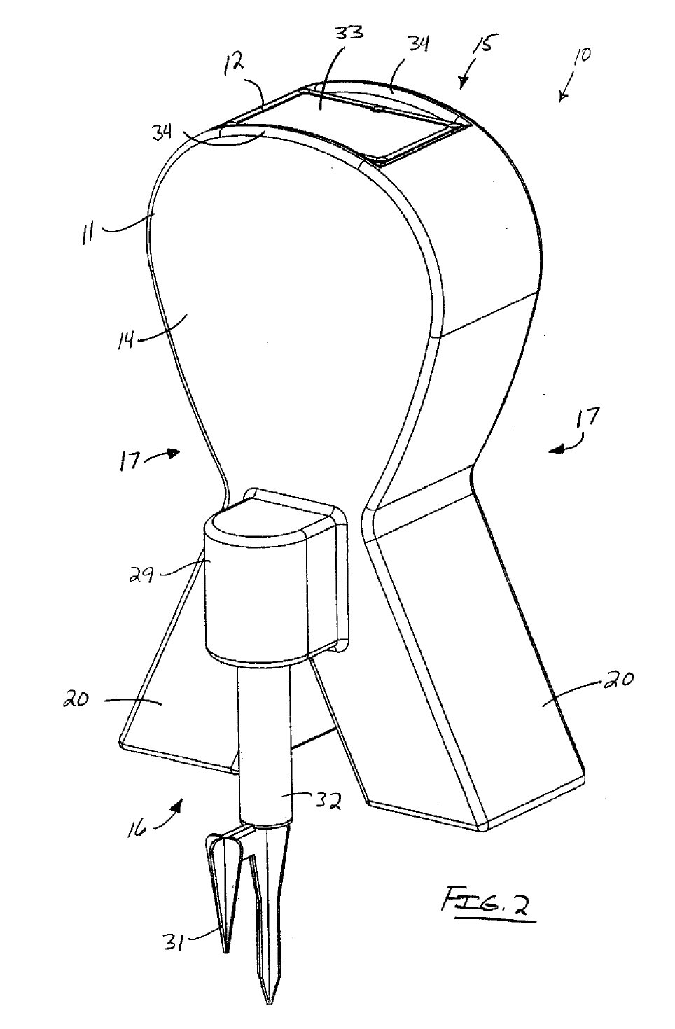

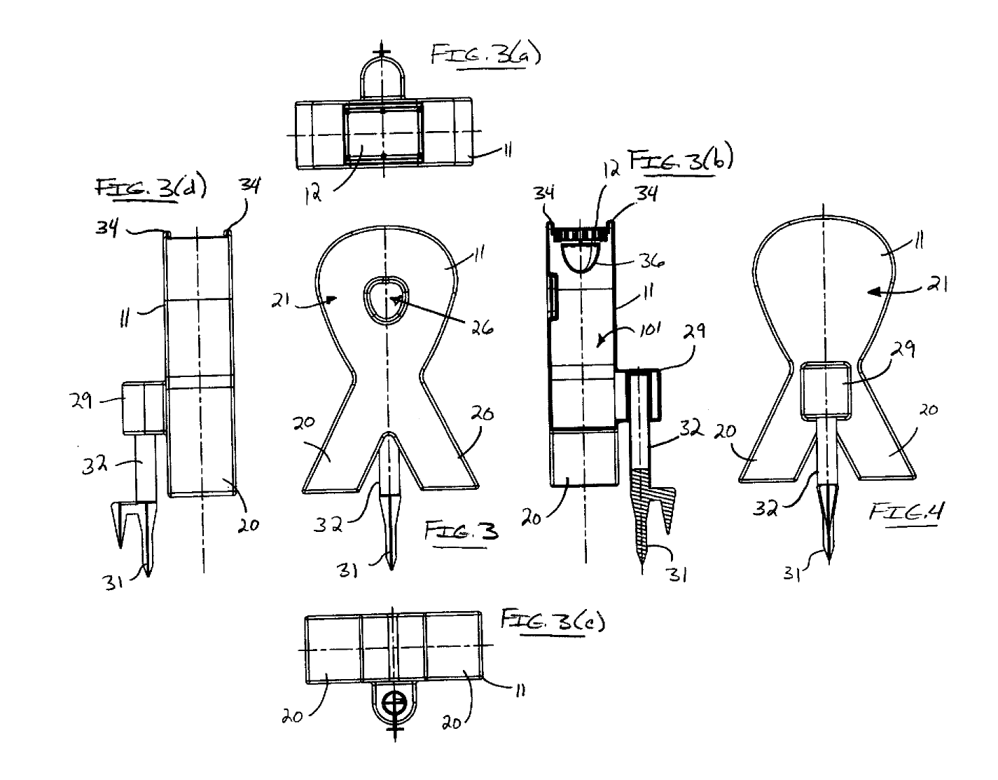

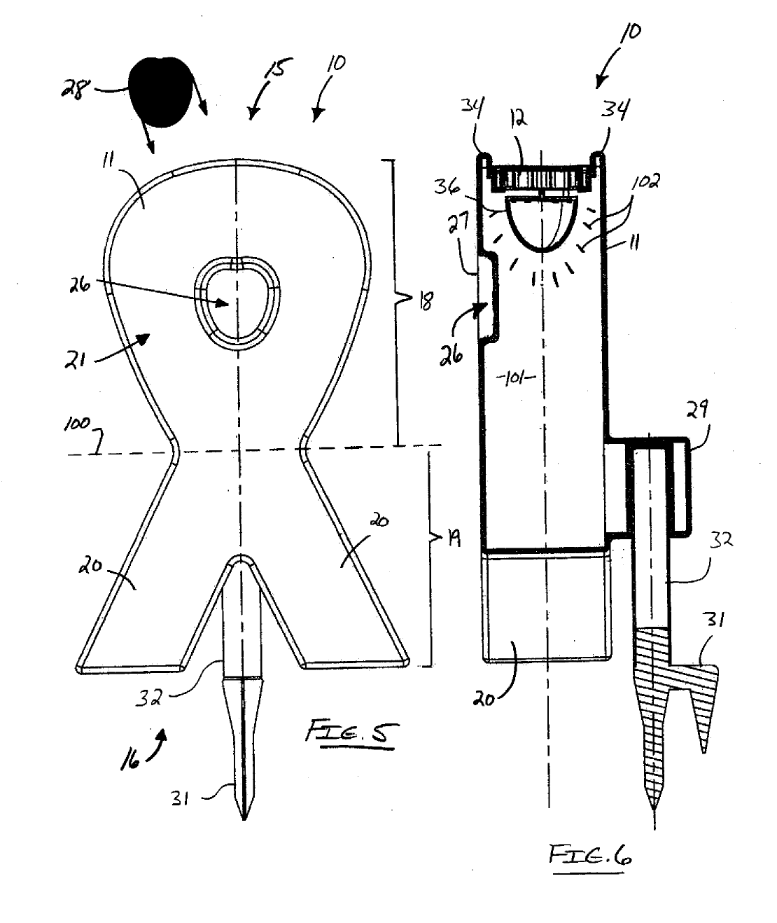

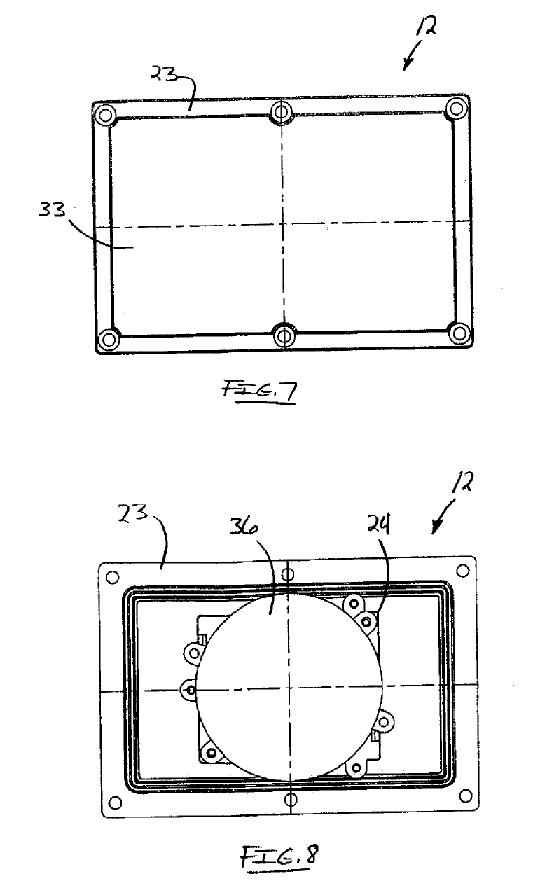

As may be seen from a comparative inspection of FIGS. 3, 4, 5, and 18, the anterior ribbon or form portion 13 and the posterior ribbon or form portion 14 each preferably define or comprise an awareness ribbon shape. The awareness ribbon shape according to the present invention may be defined by an upper portion 18 having an inverted tear drop shape superior to or above the transverse plane 100 integrally coupled with or to the lower portion 19 having an inverted V-shape or a Λ-shape inferior to or below the transverse plane 100.

Alternatively, the awareness ribbon shape according to the present invention may be defined a general X-shape intermediate the inferior end 16 and the superior end 15 capped by an arcuate cross bar at the superior end of the X-shape. In either description, the lower ribbon portion 19 thus visually presents anteriorly and posteriorly opposed legs as at 20, and the upper portion thus visually presents anteriorly and posteriorly an inverted tear drop shape as at 21.

The anterior ribbon or form portion preferably comprises a centrally located depression as at 26, which centrally located depression 26 is designed to resemble an aperture formed in the non-depressed, planar surfacing 27 of the anterior ribbon or form portion 13 as a means to accentuate the awareness ribbon shape as awareness ribbons typically comprise a looped ribbon forming a through portion or aperture at the looped. The depression 26 according to the present invention attempts to mimic the through portion or aperture of the looped portion of an awareness ribbon.

It is contemplated that the centrally located depression 26 may be further outfitted with an opaque structure 28 for preventing light transmission through the semi-transparent material at the centrally located depression 26. In this regard, it is contemplated that the opaque structure 28 may take the form of an (blackened) opaque sticker or similar other non-transparent material that may be fastened to the depression 26 preferably by way of adhesive means for enhancing aperture resemblance and accentuating the awareness ribbon shape as generally depicted in FIG. 18.

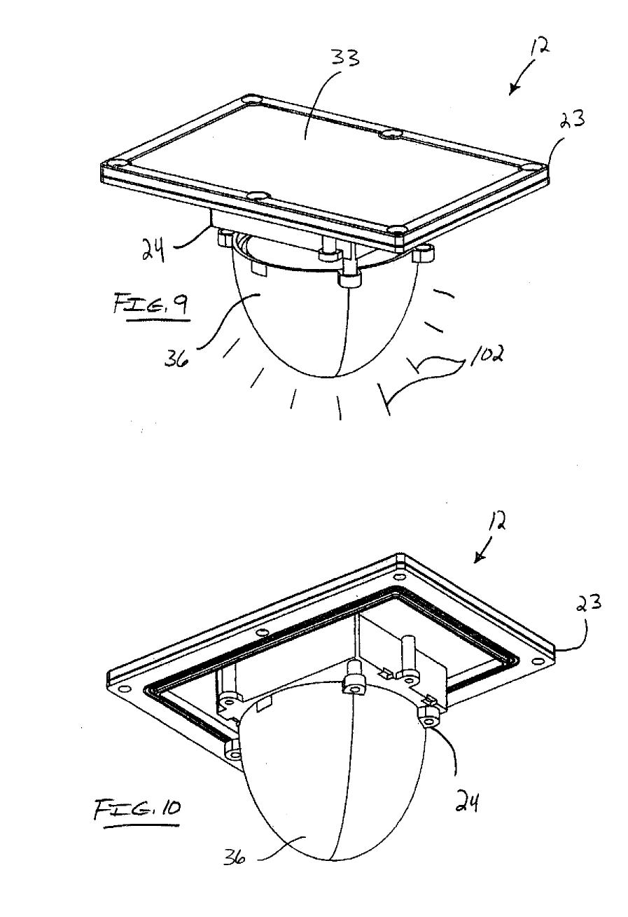

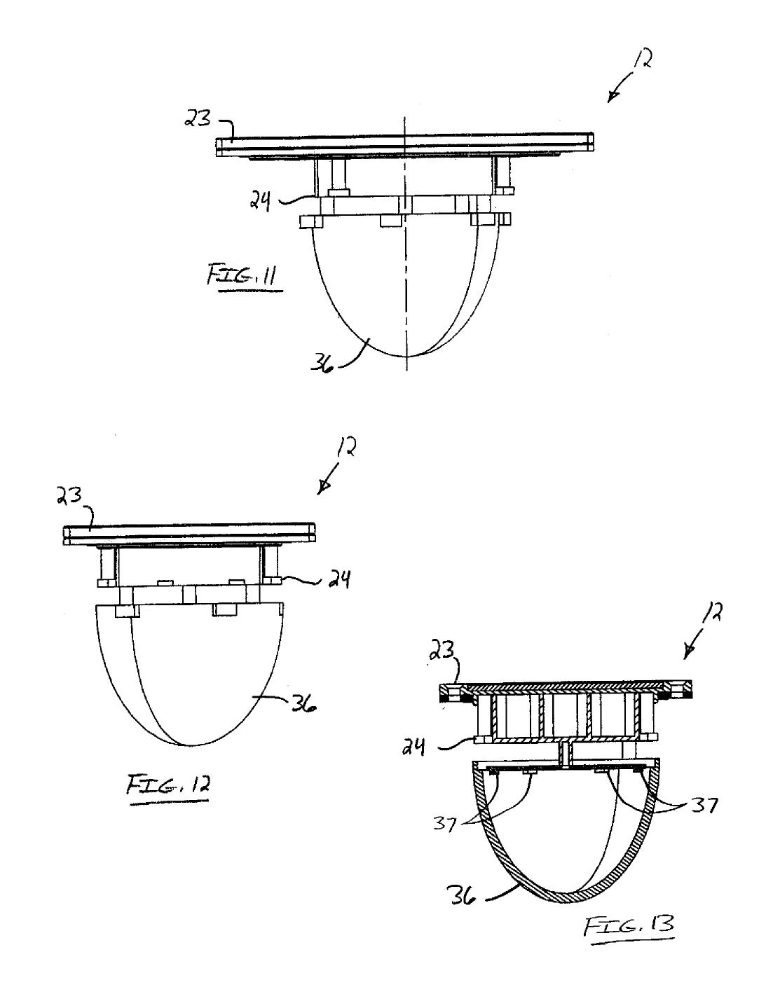

The superior ribbon or form end 15 preferably comprises an assembly-receiving aperture as at 22 intermediate the anterior ribbon or form portion 13 and the posterior ribbon or form portion 14 which aperture 22 is preferably sized and shaped to receive the cap assembly 12. The cap assembly 22 preferably comprises a superior or upper aperture closing construction as at 23; and an inferior or lower light assembly as at 24. The light assembly 24 thus extends downwardly from the closing construction 23 as generally depicted in FIGS. 9-13.

The cap assembly 12 is receivable in the assembly-receiving aperture 22, and the closing construction 23 effectively functions to close or cap the assembly-receiving aperture 22. It is contemplated that the assembly-to-aperture interface may be preferably outfitted with certain gasket means to prevent moisture from entering the inner space 101 of the form 11 (e.g. during rainy or wet environmental conditions). Should moisture penetrate the cap assembly and enter the inner space 101, it is contemplated that the form may be further outfitted with certain drainage means as exemplified by apertures 25 formed in the legs 20.

The superior or upper closing construction 23 of the cap assembly 12 preferably comprises a solar panel as at 33 in electrical communication with the light assembly 24 for sourcing electrical power thereto. It will be readily understood from a consideration of the figures supporting these specifications that the solar panel 33 and/or the closing construction 23 is/are preferably and substantially planar and coplanar with the assembly-receiving aperture 22.

In this regard, it will be further understood that the anterior ribbon or form portion 13 and the posterior ribbon or form portion 14 extend upwardly at raised portions 34 adjacent the solar panel 33 for concealing the solar panel 33 from anterior and posterior perspectives as in FIGS. 3, 4, 5, and 18. The lateral perspective thus shows a flat portion as at 35 intermediate the two raised portions 34 of the anterior ribbon or form portion 13 and the posterior ribbon or form portion 14.

The light assembly 24 preferably comprises a downwardly extending light-diffusing globe as at 36, which light-diffusing globe 36 essentially functions to diffuse light within the space 101 or internally relative to the awareness ribbon construction or form 11. The light sources are preferably Light Emitting Diodes (LED's) as generally depicted and referenced at 37.

The light assembly 24 of the cap assembly 12 essentially functions to provide illumination as at 102 via the LED's 37 and globe 36 internally within the space 101 of the awareness ribbon construction or form 11, and the semi-transparent material construction of the form 11 allows illumination 102 to pass therethrough as generally depicted in FIG. 18. The illumination 102 enables passersby to more readily visualize the internally illuminated awareness ribbon construction or form 11 as may be exemplified in relatively low light conditions.

The novelty lamp assembly 10 is preferably may preferably be outfitted with certain anchoring means to anchor the assembly 10 to a support surface. In this regard, it is contemplated that the posterior ribbon or form portion 14 may preferably outfitted with said anchoring means for anchoring the lamp assembly 10 to a support surface as typified by earth as at 104 in FIG. 18.

More particularly, the posterior ribbon or form portion 14 may preferably comprise a stake assembly receiving projection as at 29, which projection comprises an aperture as at 30 for receiving a stake assembly. The anchoring means according to the present invention may accordingly be exemplified and/or being defined by a stake assembly (in combination with the projection 29) comprising an earth- (or surface-) penetrative stake as at 31, and a tube as at 32, which tube 32 interfaces intermediate the projection 29 via the aperture 30 and the earth-penetrative stake 31.

While the foregoing specifications set forth much specificity, the same should not be construed as setting forth limits to the invention but rather as setting forth certain preferred embodiments and features. For example, it is contemplated that the foregoing specifications support a novelty lamp assembly generally having an awareness ribbon shape for providing an illuminated novelty in low light conditions. The lamp assembly according to the present invention is believed to essentially comprise a three-dimensional form, and a cap assembly.

The three-dimensional form is preferably constructed from a light penetrative material and comprises an anterior portion, a posterior portion, laterally opposed portions, a superior end, an inferior end, and a transverse plane intermediate the superior and inferior ends defining an upper portion and a lower portion. The anterior and posterior portions comprise an awareness ribbon shape, and the superior end comprising an assembly-receiving aperture intermediate the anterior and posterior portions.

The cap assembly preferably comprises an aperture closing construction and a light assembly. The light assembly projects away from the closing construction, and is receivable in the assembly-receiving aperture and fastenable to the three-dimensional form. The closing construction essentially closes the assembly-receiving aperture, and the light assembly provides illumination internally to the three-dimensional form. The light-penetrative material enables passersby to visualize the internally illuminated three-dimensional form in low light conditions.

Stated another way, the novelty lamp assembly according to the present invention preferably and essentially comprises an illuminable form as exemplified by form 11. The illuminable form necessarily comprises a(n) (looped) awareness ribbon shape in a first dimension as generally depicted in anterior/posterior perspectives in the frontal and rear elevational views in FIGS. 3, 4, and 5. Certain illumination means cooperate with the illuminable form for providing illumination, and illuminating the awareness ribbon shape.

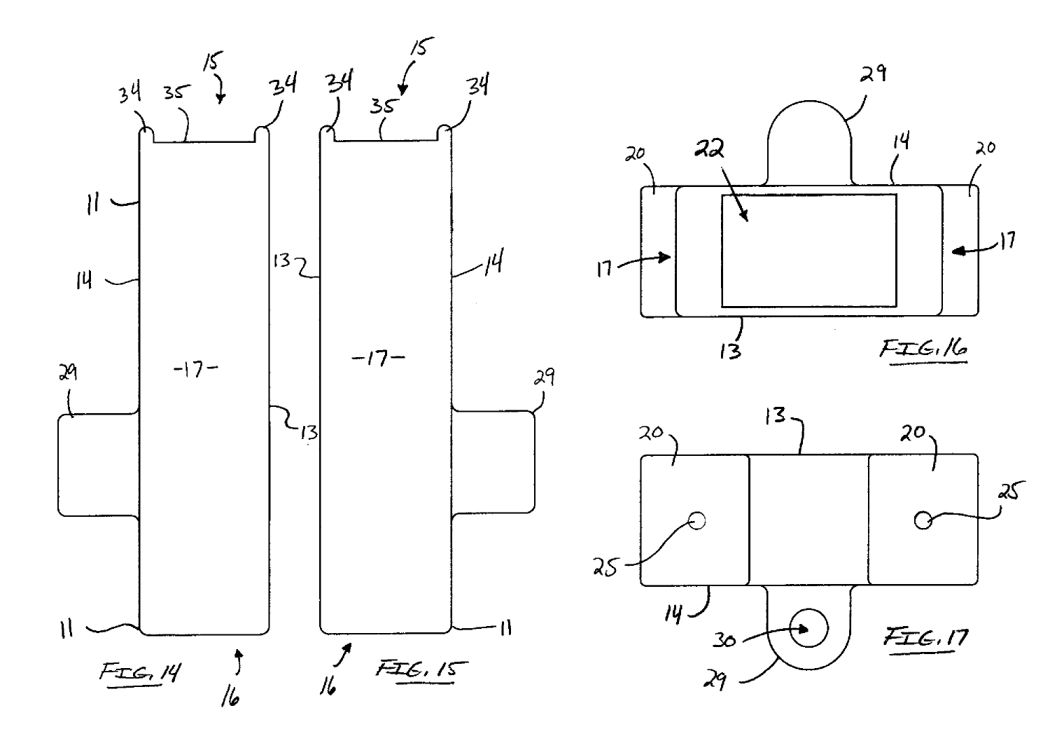

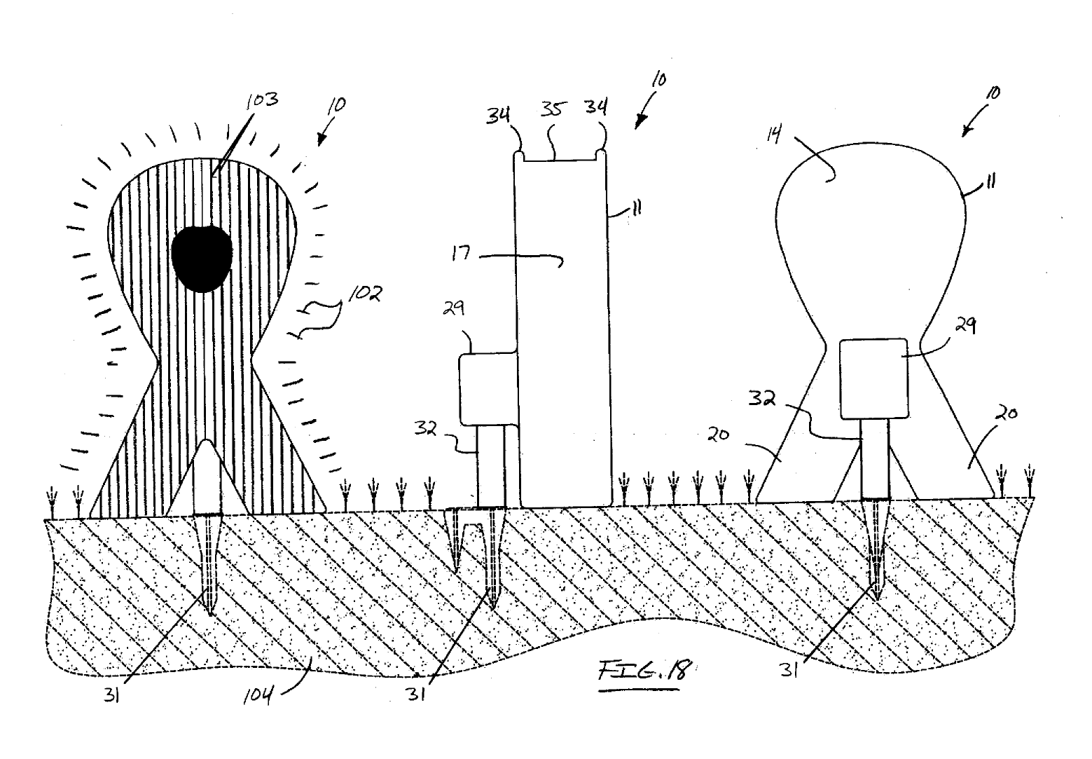

The illuminable form may preferably be three-dimensional and generally rectangular in (A) a second dimension as generally depicted in lateral perspectives in lateral elevational views in FIGS. 3(d), 14, and 15; and (B) a third dimension as generally depicted in top and bottom perspectives in top and bottom (plan) views in FIGS. 3(a), 3(c), 16, and 17.

The generally rectangular form in the third dimension comprises an upper end (as at 15), which upper end 15 has a truncated U-shape defined by the raised portions 34 and the flat portion 35 extending therebetween. The illumination means are preferably received at and within the truncated U-shape such that the awareness ribbon shape obscures the illumination means in the first dimension.

Accordingly, although the invention has been described by reference to certain preferred and alternative embodiments, it is not intended that the novel arrangements be limited thereby, but that modifications thereof are intended to be included as falling within the broad scope and spirit of the foregoing disclosures and the appended drawings.

I claim:

1. An awareness ribbon novelty lamp assembly for providing an illuminated awareness novelty in low light conditions, said lamp assembly comprising:
a three-dimensional, awareness ribbon construction, the awareness ribbon construction being constructed from a light-penetrative material and comprising an anterior ribbon portion, a posterior ribbon portion, a superior ribbon end, an inferior ribbon end, laterally opposed ribbon portions, and a transverse ribbon plane intermediate the superior and inferior ribbon ends defining an upper ribbon portion and a lower ribbon portion, the anterior and posterior ribbon portions comprising an awareness ribbon shape, the lower ribbon portion thus visually presenting anteriorly and posteriorly opposed legs and the upper portion thus visually presenting anteriorly and posteriorly an inverted tear drop shape, the superior ribbon end comprising an assembly-receiving aperture intermediate the anterior and posterior ribbon portions; and
a cap assembly, the cap assembly comprising a superior aperture closing construction and an inferior light assembly, the light assembly thus extending downwardly from the closing construction, the light assembly being receivable in the assembly-receiving aperture, and the closing construction for capping the assembly-receiving aperture, the light assembly for providing illumination internally to the awareness ribbon construction, the light-penetrative material for enabling onlookers to visualize the internally illuminated awareness ribbon construction in low light conditions.

2. The lamp assembly of claim 1 wherein the anterior ribbon portion at the upper portion comprises a centrally located depression, the centrally located depression for resembling an aperture and accentuating the awareness ribbon shape.

3. The lamp assembly of claim 2 wherein the centrally located depression is outfitted with an opaque structure, the opaque structure for preventing light transmission through the light-penetrative material at the centrally located depression, the opaque structure thus for enhancing aperture resemblance.

4. The lamp assembly of claim 1 wherein the awareness ribbon construction comprises select coloration, the select coloration for conveying awareness ribbon meaning to passersby.

5. The lamp assembly of claim 1 wherein the posterior ribbon portion is outfitted with anchoring means for anchoring the lamp assembly to a support surface.

6. The lamp assembly of claim 5 wherein the posterior ribbon portion comprises a stake assembly receiving projection, the projection for receiving a stake assembly, the anchoring means being defined by the combination of the projection and stake assembly, the stake assembly comprising an earth-penetrative stake, and a tube, the tube for interfacing intermediate the projection and the earth-penetrative stake.

7. The lamp assembly of claim 1 wherein the superior closing construction comprises a solar panel, the solar panel being in electrical communication with the light assembly for sourcing power thereto.

8. The lamp assembly of claim 7 wherein the solar panel is substantially planar and coplanar with the assembly-receiving aperture.

9. The lamp assembly of claim 8 wherein the anterior ribbon portion and the posterior ribbon portion extend upwardly adjacent the solar panel at upwardly raised portions for concealing said solar panel from anterior and posterior view points, the lateral view point thus showing a flat portion intermediate the upwardly raised portions.

10. The lamp assembly of claim 9 wherein the light assembly comprises a downwardly extending light-diffusing globe, the light-diffusing globe for diffusing light internally relative to the awareness ribbon construction.

11. A novelty lamp assembly for providing an illuminable novelty, said lamp assembly comprising:
a three-dimensional form, the three-dimensional form being constructed from a light-penetrative material and comprising an anterior portion, a posterior portion, laterally opposed portions, a superior end, an inferior end, and a transverse plane intermediate the superior and inferior ends defining an upper portion and a lower portion, the anterior and posterior portions comprising an awareness ribbon shape, the superior end comprising an assembly-receiving aperture intermediate the anterior and posterior portions; and
a cap assembly, the cap assembly comprising an aperture closing construction and a light assembly, the light assembly projecting from the closing construction, the light assembly being receivable in the assembly-receiving aperture, and the closing construction for closing the assembly-receiving aperture, the light assembly for providing illumination internally to the three-dimensional form, the light-penetrative material for enabling onlookers to readily visualize the internally illuminated three-dimensional form.

12. The lamp assembly of claim 11 wherein the anterior portion comprises a depression, the depression for resembling an aperture and accentuating the awareness ribbon shape.

13. The lamp assembly of claim 12 wherein the depression is outfitted with an opaque structure, the opaque structure for preventing light transmission through the light-penetrative material at the depression, the opaque structure thus for enhancing aperture resemblance.

14. The lamp assembly of claim 11 wherein the superior closing construction is defined by a solar panel, the solar panel being in electrical communication with the light assembly for sourcing power thereto.

15. The lamp assembly of claim 14 wherein the solar panel is substantially planar and coplanar with the assembly-receiving aperture.

16. The lamp assembly of claim 15 wherein the anterior portion and the posterior portion extend upwardly adjacent the solar panel for concealing said solar panel from anterior and posterior view points.

17. The lamp assembly of claim 13 wherein the light assembly comprises a light-diffusing globe, the light-diffusing globe for diffusing light internally relative to the three-dimensional form.

18. A novelty lamp assembly comprising:
an illuminable form, the illuminable form comprising an awareness ribbon shape in a first dimension; and
illumination means for providing illumination, the illumination means being cooperable with the illuminable form for illuminating the awareness ribbon shape.

19. The novelty lamp assembly of claim 18 wherein the illuminable form is rectangular in a second and a third dimension.

20. The novelty lamp assembly of claim 19 wherein the rectangular form in the third dimension comprises an upper end, the upper end having a truncated U-shape, the illumination means being received within the truncated U-shape, the awareness ribbon shape obscuring the illumination means in the first dimension.
